(19) United States
(12) Patent Application Publication
(10) Pub. No.: US 2024/0423165 A1
(43) Pub. Date: Dec. 26, 2024

(54) Livestock Squeeze Chute

(71) Applicant: Daniels Manufacturing Co., Ainsworth, NE (US)

(72) Inventors: Jim Dougherty, Ainsworth, NE (US); Kade Blake, Ainsworth, NE (US); Shane Jones, Ainsworth, NE (US); Wayne Dutrow, Ainsworth, NE (US); Danny Daniels, Ainsworth, NE (US)

(73) Assignee: Daniels Manufacturing Co., Ainsworth, NE (US)

(21) Appl. No.: 18/750,362

(22) Filed: Jun. 21, 2024

Related U.S. Application Data
(60) Provisional application No. 63/509,392, filed on Jun. 21, 2023.

(51) Int. Cl. A01K 15/04

(52) U.S. Cl. CPC A01K 15/04

(57) ABSTRACT

An improved squeeze chute, which may be portable or stationary, includes a frame having an entrance end, an exit end, a first side, a second side, an upper end and a lower end. A first squeeze sidewall is positioned on a first side of the frame and a second sidewall is positioned on a second side of the frame. The sidewalls are movable between inner and outer positions with respect to the frame by pivot arms that pivotally link each sidewall to a single hydraulically actuatable slide rail assembly. Embodiments of the chute include entrance gate members and exit gate members. The exit gate members being movable horizontally between open and closed positions by hydraulic actuation. Embodiments of the chute include a removeable and vertically adjustable sternum bar that is receivable into a receiver bar at the exit end of the chute.

### CROSS REFERENCE TO RELATED APPLICATIONS

The present application is a utility filing claiming priority to U.S. Provisional Application No. 63/509,392; filed on Jun. 21, 2023, the entire contents of which is incorporated by reference herein.

### TECHNICAL FIELD

Embodiments disclosed are directed to the field of livestock handling apparatuses and more specifically to squeeze chutes for selectively immobilizing an animal in a standing position to allow any number of operations to be safely performed on the animal.

### BACKGROUND

Hydraulically operable livestock squeeze chutes such as the type shown and described in U.S. Pat. Nos. 6,609,480; and 8,240,276 are known. Similarly, it is know that such squeeze chutes may be made portable, in the manner taught in U.S. Pat. No. 7,677,205. The prior squeeze chutes described in these references are exemplars for the variety of features they disclosed for providing improved operational functionality and animal handling performance as compared to older/other existing squeeze chute apparatuses. The entire contents of U.S. Pat. Nos. 6,609,480; 7,677,205; and 8,240,276 are incorporated herein by reference.

Embodiments of the squeeze chute described herein likewise provide improved operational characteristics and performance over known squeeze chute apparatuses.

### SUMMARY

Embodiments of the squeeze chute apparatus disclosed herein include an elongated frame in the form of a chute having upper and lower ends, a first side, a second side, an entrance or tail end, and an exit or head end. First and second movable entrance gate members are secured to the frame at the entrance end of the frame and are supported by a horizontal entrance support bar, and first and second exit gate members are horizontally movably secured to the frame at the exit end of the frame and are supported by a horizontal exit support bar. First and second upstanding squeeze sidewalls are provided along the sides of the frame, which are movable between inner and outer positions. When the sidewalls are in their inner position, they squeeze or crowd an animal positioned within the squeeze chute.

A neck stretcher assembly is provided at the exit end of the frame external to the exit gate to immobilize the head of the animal that extends out beyond the exit gate when the animal is positioned in the squeeze chute apparatus.

The entrance gate members, the exit gate members, the squeeze sidewalls and the neck stretcher are each moveable via one or more hydraulic cylinders attached thereto. Each of the cylinders has a resilient mount at its base end and a resilient mount at its rod end which reduces the noise normally associated with the movement of the entrance gates, the exit gates, and the sidewalls. Further, the resilient mounts at the base end and rod end of the hydraulic cylinders reduce metal-to-metal contact thereby reducing the amount of maintenance and/or repair normally associated with a squeeze chute apparatus.

In at least one embodiment, the entrance gates are each supported from the horizontal entrance support bar by a pair of upper brackets which have rollers, wheels, casters, etc. that are mounted in an internal track or guide rail within a horizontal entrance support bar. Each of the brackets include one or more support fasteners that act as bumpers or guides that ensure minimal incidental contact between the entrance gates and the support bar, thereby minimizing noise and wear between the components.

In some embodiments, the horizontal exit support bar contains an upper chain drive mechanism that is connected to a first head gate hydraulic arm by a chain drive engagement plate. The upper bracket of each head gate member is coupled to the upper chain drive, such that when the hydraulic rod of the arm extends or retracts, the upper chain drive mechanism causes both head gate members to move between the open and closed position.

In some embodiments a horizontal exit track bar defines a track into which a portion of each of the exit gate members is movable within. In some embodiments the horizontal exit track bar contains a lower chain drive mechanism to which each of the exit gate members is coupled thereto by a lower bracket. The upper chain drive mechanism and the lower chain drive mechanism are mechanically coupled together by a mechanical drive shaft, such that when the first head gate hydraulic arm engages the upper chain drive mechanism, the mechanical drive shaft causes the lower chain drive mechanism to be engaged simultaneously.

In some embodiments, the head gate members are individually actuatable between open and closed positions. In at least one embodiment, the head gate bar includes a first headgate hydraulic arm and a second headgate hydraulic arm. Each hydraulic arm extends from the headgate bar to a six-point linkage assembly positioned between a side bar of the frame and one of the head gate members. When one of the headgate hydraulic arms is activated, a central member or link bar of the six-point linkage is pulled toward or pushed away from the hydraulic arm resulting in the gate member being moved between the opened or closed position.

The neck stretcher assembly is comprised of a first head immobilizer shaft and a second head immobilizer shaft. The first shaft is pivotally mounted to the first exit gate member adjacent to its upper bracket. The second shaft is pivotally mounted to the second exit gate member adjacent to its upper bracket. The first and second immobilizer shafts extend substantially along an interior edge of the of the first exit gate member and second exit gate member respectively.

In at least one embodiment, the squeeze side walls are pivotally engaged to a single actuation slide which is disposed about an actuation rail positioned along the upper end of the squeeze chute. A squeeze hydraulic arm is secured to the frame and the and actuation slide, whereby when the rod of the squeeze hydraulic arm is extended or retracted, the sidewalls are actuated between a closed position (a first horizontal distance apart) and an opened position (a second, greater horizontal distance apart than the first horizontal distance).

The lower end of the frame defines a floor that extends between right and left sidewalls, and from the entrance end to the exit end.

A vertically adjustable sternum bar is removeably engaged to a sternum bar receiver which is mounted to the floor at the exit end of the squeeze chute. The receiver defines a shaft into which the adjustable sternum bar may be received and engaged to the base via a receiver pin.

In at least one embodiment, the lower end may include wheel and axle assembly mounting surfaces, brackets or plates where a wheel and axle assembly may by mounted to the base of the chute to provide it with mobility.

In at least one embodiment, the receiver shaft is sized and shaped to receive a standard tow hitch receiver therein.

### BRIEF DESCRIPTION OF THE DRAWINGS

FIGS. 1-20 show various views and components of exemplary embodiments of the livestock squeeze chute described herein.

FIG. 1 is a entrance side perspective view of an embodiment of the squeeze chute shown with the control swing arm extended for operation and the entrance gate shown in the closed position.

FIG. 2 is a partial side view of the embodiment shown in FIG. 1 showing the pivotal relationship of the swing arm to the frame of the squeeze chute.

FIG. 3 is an entrance side view of the embodiment shown in FIG. 1, wherein the entrance gate members are shown in the closed position.

FIG. 4 is a partial perspective, entrance side view of the embodiment shown in FIG. 4, wherein the entrance gate members are shown in the open position.

FIG. 5 is an exit side perspective view of the embodiment shown in FIG. 1 showing a first embodiment of the exit gate, with the exit gate members shown in the closed position.

FIG. 6 is an exit side perspective view of the embodiment shown in FIG. 5, wherein the exit gate members are shown in the open position.

FIG. 7 is a partial sectional view of top head gate bar shown in FIGS. 5-6 and depicting various components contained therewithin (chain drive) and engaged thereto.

FIG. 8 is a more detailed sectional view of the embodiment shown in FIG. 7.

FIG. 9 is a schematic view of the chain drive assembly and related components utilized in the embodiment shown in FIGS. 5-8.

FIG. 10 is a partially exposed view of an alternative embodiment of the exit gate that does not utilize the chain drive assembly of FIGS. 5-9.

FIG. 11 is an exit gate end view of the embodiment shown in FIG. 10, wherein the exit gate members are shown in the closed position.

FIG. 12 is an exit gate end view of the embodiment shown in FIGS. 10 and 11, wherein the exit gate members are shown in the open position.

FIG. 13 is a partial entrance end view of the embodiment shown in FIG. 1, wherein the squeeze walls are shown in an open position.

FIG. 14 is a partial perspective view of the upper portion of the frame 12 of the embodiment shown in FIG. 13, depicting the slide rail assembly for actuating the squeeze walls.

FIG. 15 is a partial entrance end view of the embodiment shown in FIG. 13, wherein the squeeze walls are shown in a closed position.

FIGS. 16 and 17 are partial first side view of the embodiment shown in FIGS. 13-15, and depicting the transition of the first squeeze wall from the open position to the closed position.

FIG. 18 is a partial exit side view of the base of the embodiment shown in FIG. 1, depicting the adjustable sternum bar assembly.

FIG. 19 is a partial exit side view of the embodiment shown in FIG. 18 with the sternum bar removed from the receiver shaft.

FIG. 20 is a perspective view of the sternum bar shown in FIG. 18, having been removed from the receiver shaft shown in FIG. 19.

The many features and advantages of the invention are apparent from the above description. Numerous modifications and variations will readily occur to those skilled in the art. Since such modifications are possible, the invention is not to be limited to the exact construction and operation illustrated and described.

### DETAILED DESCRIPTION

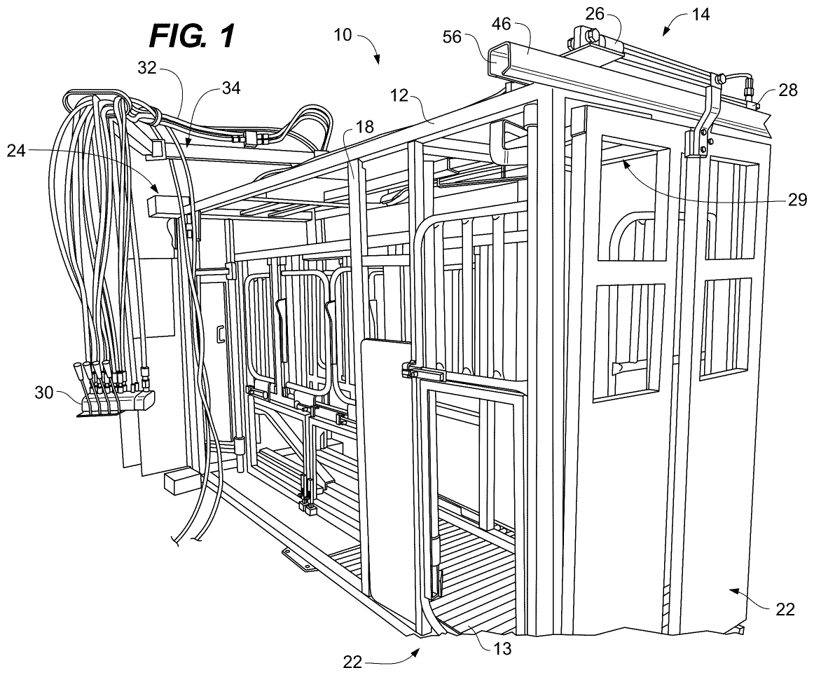

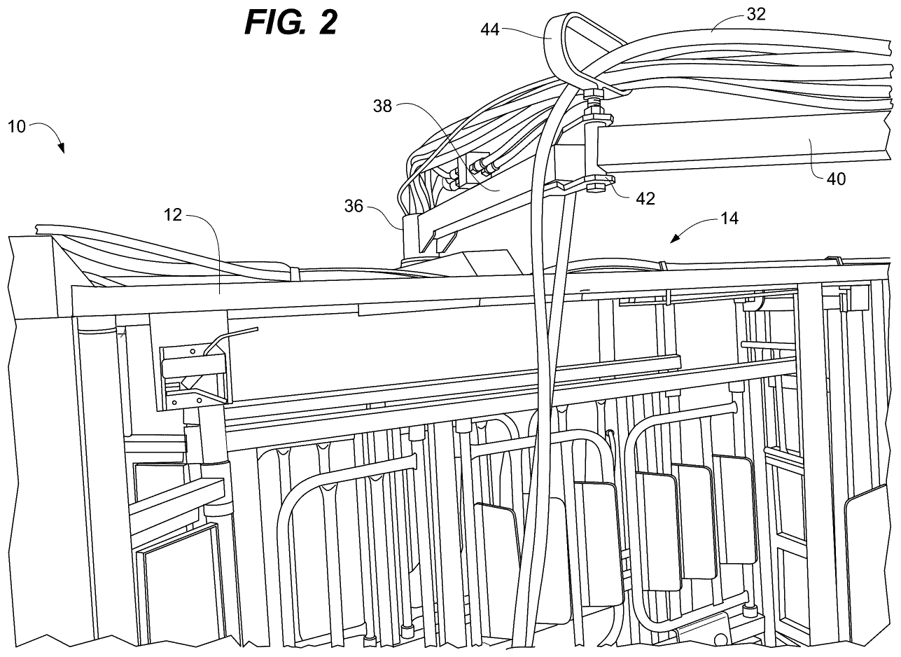

Embodiments of the squeeze chute apparatus 10 are shown in FIGS. 1-33. In the exemplary embodiment shown in FIG. 1, it is illustrated that the squeeze chute 10 includes an elongated frame 12 in the form of a chute having an upper end or top 14, a lower end or base 16, a first side 18, a second side 20, an entrance or tail end 22, and an exit or head end 24.

The base 16 of the frame 12, defines a floor 13 which is both sufficiently strong and wide enough to accommodate the weight and bulk of common livestock that may be positioned within the squeeze chute 10.

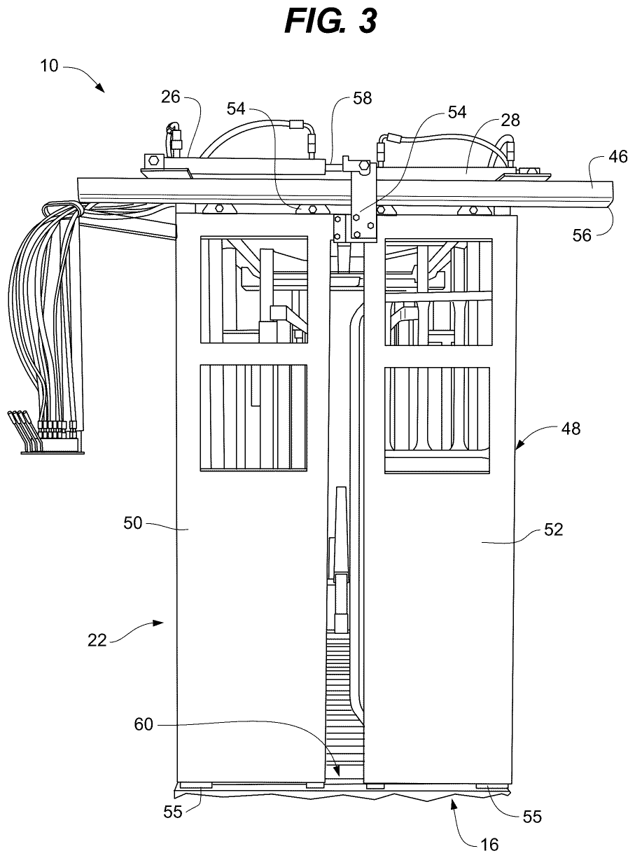

As shall be discussed in greater detail below, various components of the squeeze chute 10 are actuatable via hydraulic cylinders, such as first entrance gate hydraulic cylinder 26 and second entrance gate hydraulic cylinder 28 visible in FIG. 1. Each hydraulic cylinder is connected to a control panel 30 via hydraulic lines 32. The control panel 30 is connected to an adjustable swing arm 34, which is pivotally mounted to the top 14 of the frame 12 at a pivot mount 36 shown in FIG. 2. By this connection the control panel 30, shown in FIG. 1, may be pivotally swung about the sides of the frame 12 to any location desired by a user (not shown).

To provide for an even greater range and flexibility of motion, in some embodiments, the swing arm 34 is comprised of a multiple arm sections, such as first section 38 and second section 40, such as are shown in FIG. 2, which are joined by a spindle joint connection 42. Spindle joint connection 42, allows the second section 40 to be freely rotatable relative to the first section 38 of the adjustable swing arm 34.

In some embodiments, the swing arm 34 includes at least one line harness 44 to support and collect the various hydraulic lines 32 of the squeeze chute 10 in the manner shown in FIG. 2. In at least one embodiment the harness 44 is supported by the spindle joint connection 42.

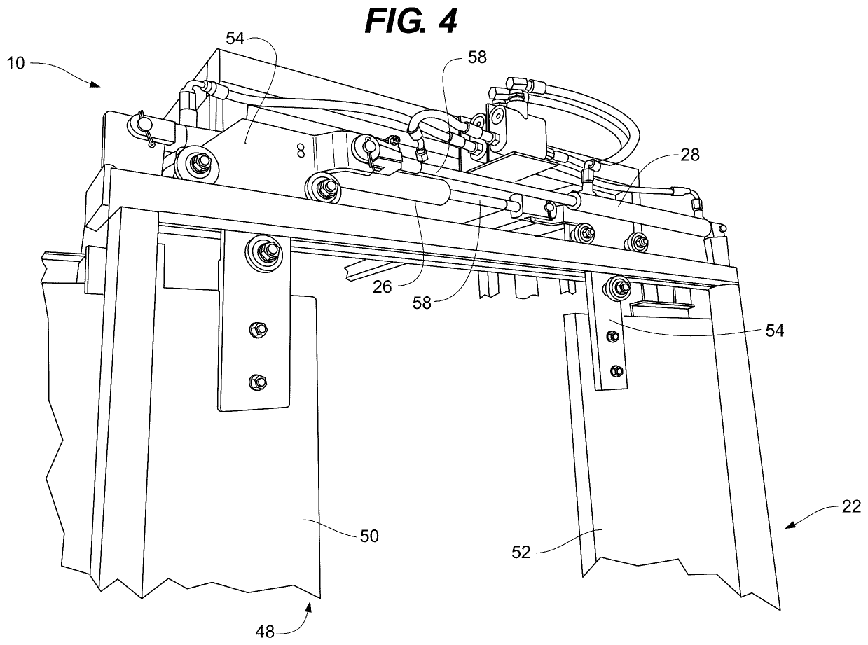

As shown in FIG. 3, at the entrance end 22 of the frame 12, the frame includes horizontal entrance support bar 46, which supports an entrance gate 48. The entrance gate 48 is comprised of a first moveable entrance gate member 50 and a second movable entrance gate member 52, each of which are movably connected to and supported by the horizontal entrance support bar 46 by one or more roller bracket arms 54. The roller bracket arms 54 may include one or more, wheels, rollers, bearings, or the equivalent to allow the bracket arms, and thus the supported entrance gate members 50 and 52, to roll or slide along or within a track 56 defined by the horizontal entrance support bar 46, of which an example is visible in FIG. 1.

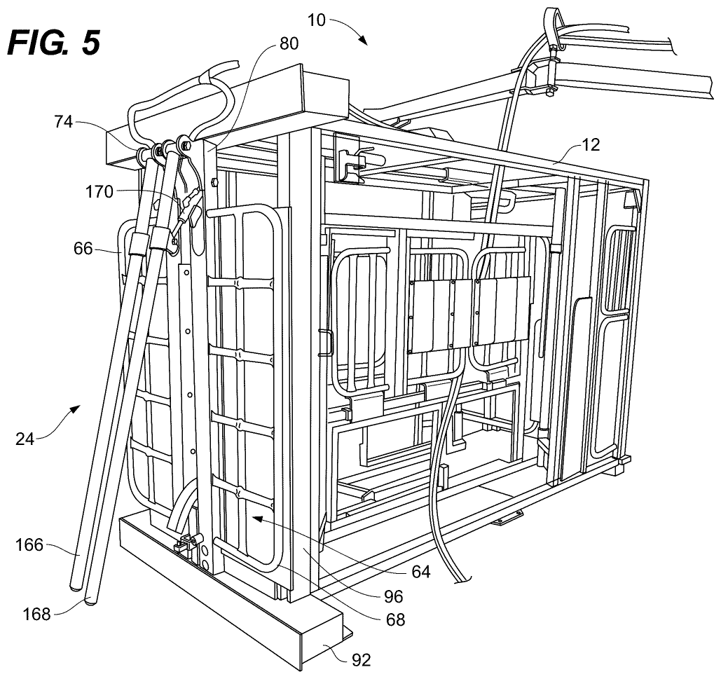

First moveable entrance gate member 50 is mechanically coupled to the extendable/retractable arm 58 of the first entrance gate hydraulic cylinder 26. Second moveable entrance gate member 52 is mechanically coupled to the extendable/retractable arm 58 of the second entrance gate hydraulic cylinder 28. Like all the hydraulic cylinders shown and described herein, the arm 58 is actuatable between an extended state and a retracted state. When one, or the other, or both entrance gate hydraulic cylinders 26 and 28 are a actuated to the extended state, the arm 58 will extend outward from the cylinder causing the respective gate member 50 and 52 to open, such as in the manner shown in FIG. 4. When one, or the other, or both entrance gate hydraulic cylinders 26 and 28 are a actuated to the retracted state, the arm 58 will retract back into the cylinder causing the respective gate member 50 and 52 to close, such in the manner shown in FIG. 3.

In some embodiments, the base 16 of the frame 12 defines an entrance gate channel 60 within which a portion of each of the entrance gate members 50 and 52 are slidably retained therein, such that when the entrance gate members 50 and 52 are moved between the closed and open positions shown in FIGS. 3 and 4 the entrance gate members 50 and 52 are prevented from swinging free from the frame 12.

As may be seen in FIG. 3, in some embodiments, the entrance gate members 50 and 52 include one or more lower roller bracket arms 55, which support the entrance gate members 50 and 52 and allow a rolling engagement within the channel 60.

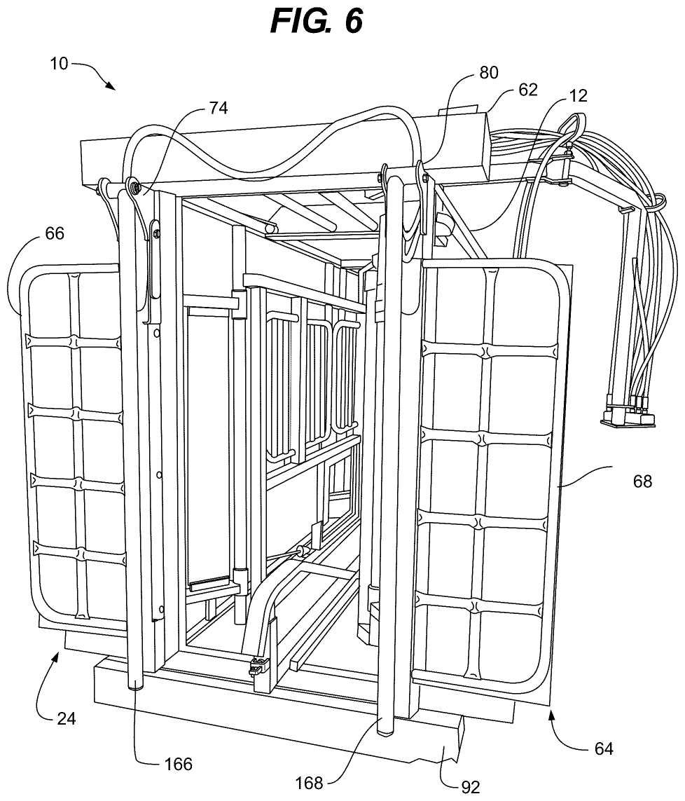

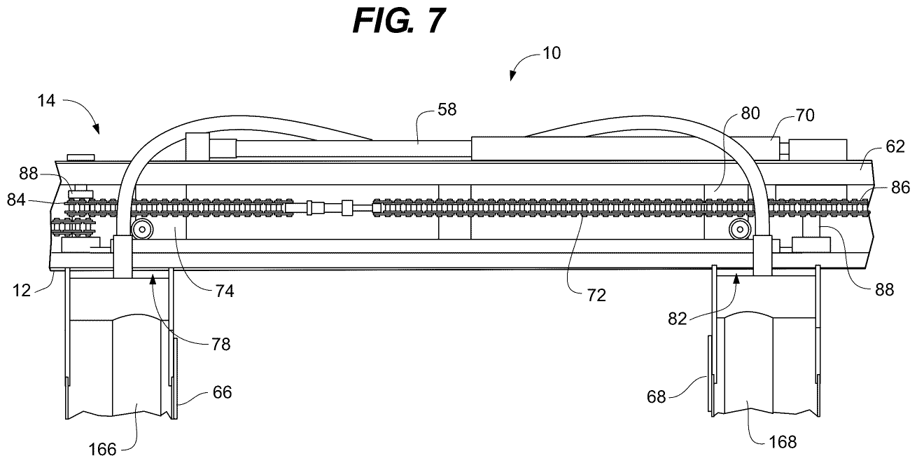

At the opposite end of the squeeze chute 10, from the entrance end 22, is the exit or head end 24. In the embodiment shown in FIGS. 5-6, the exit end 24 of the frame 12 includes top horizontal exit support bar 62, which supports an exit gate 64. The exit gate 64 is comprised of a first moveable exit gate member 66 and a second movable exit gate member 68, each of which are movably connected to and supported by the horizontal exit support bar 62.

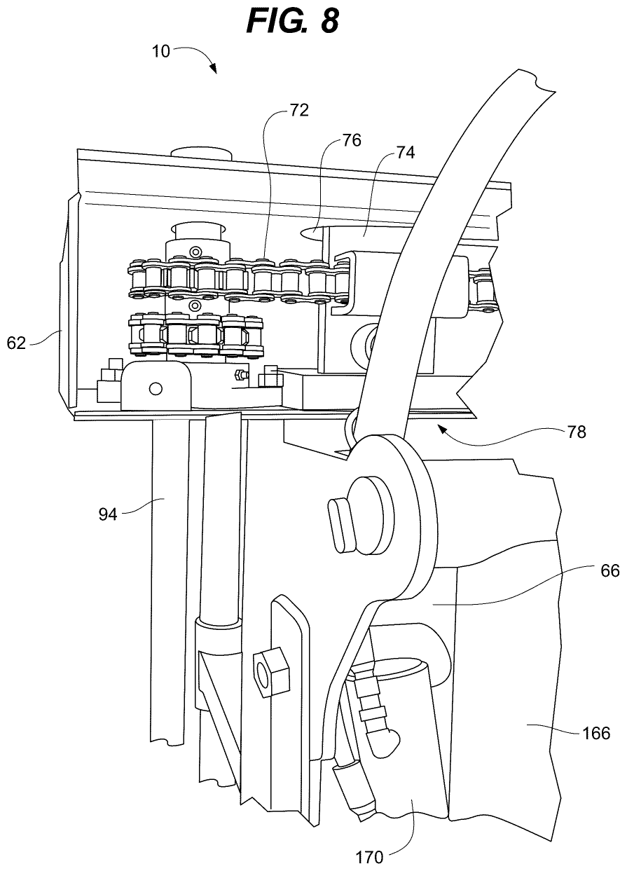

The exit gate members 66 and 68 are actuatable between a closed position shown in FIG. 5 and the open position, shown in FIG. 6. Movement of the gate members 66 and 68 is imparted by a hydraulically actuated chain drive system shown in FIGS. 7-9.

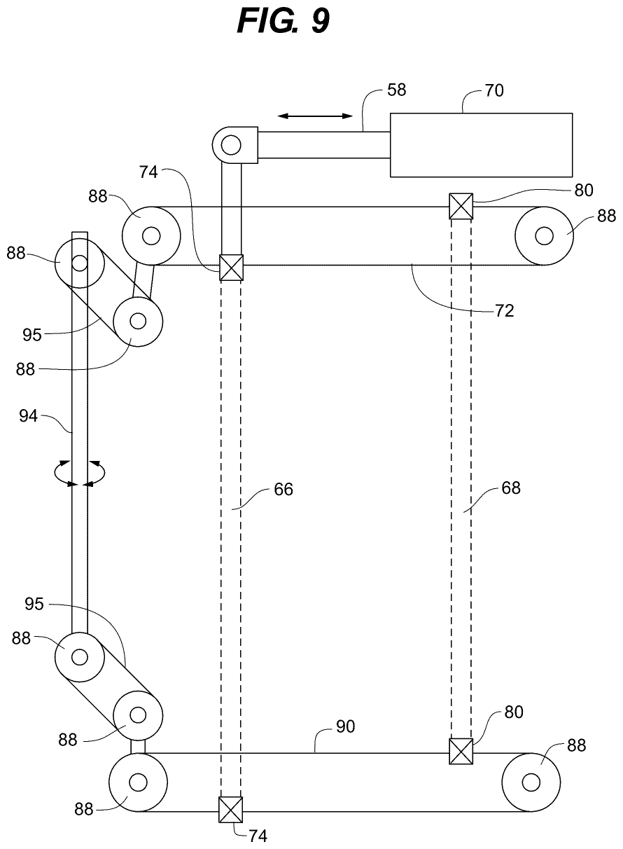

The central component of the chain drive system is shown in FIG. 7 and comprises a first hydraulic exit cylinder 70 mounted on the top 14 of the frame 12 along the horizontal exit support bar 62. The arm 58 of the cylinder 70 is coupled to a top chain 72 contained within a hollow portion of the top horizontal exit support bar 62 by first chain engagement bracket 74. As is shown in FIG. 8, the top horizontal exit support bar 62 defines a top slot 76 through which the first chain engagement bracket 74 extends to provide engagement between the hydraulic arm 58 (shown in FIG. 7) and the top chain 72. The top horizontal exit support bar 62 defines a first bottom slot 78 as well through which the first chain engagement bracket 74 descends through to engage the first exit gate member 66. The first bottom slot 78 has a length sufficient to accommodate the travel of the first chain engagement bracket 74 between the open and closed positions of the first exit gate member 66.

Returning to FIG. 7, a second chain engagement bracket 80 is similarly engaged to the top chain 72, and similarly descends through a second bottom slot 82 defined by the top horizontal exit support bar 62. Second bottom slot 82 may be continuous with the first bottom slot 78 or may be a distinct cut out portion of the horizontal exit support bar 62. Second chain engagement bracket 80 is engaged to the second exit gate member 68.

The top chain 72 is mounted in the form of a closed loop supported at each end 84 and 86 by a rotatable gear and spindle assembly 88, in the manner shown in FIG. 7. When the a first hydraulic exit cylinder 70 is activated to extend the arm 58, the first chain engagement bracket 74 is moved along the path defined by the arm 58. Due to the first hydraulic exit cylinder 70 being coupled to the top chain 72, the first chain engagement bracket 74 advances the top chain 72 and the second chain engagement bracket 80 is likewise advanced. By connecting each of the first chain engagement bracket 74 and second chain engagement bracket 80 at appropriate positions along the top chain 72, actuation of the first hydraulic exit cylinder 70 will cause the first and second exit gate members 66 and 68 to transition together to their respective opened and closed positions as the arm 58 causes the top chain 72 to advance (during extension of the arm 58) or return (during retraction of the arm 58) to its original state.

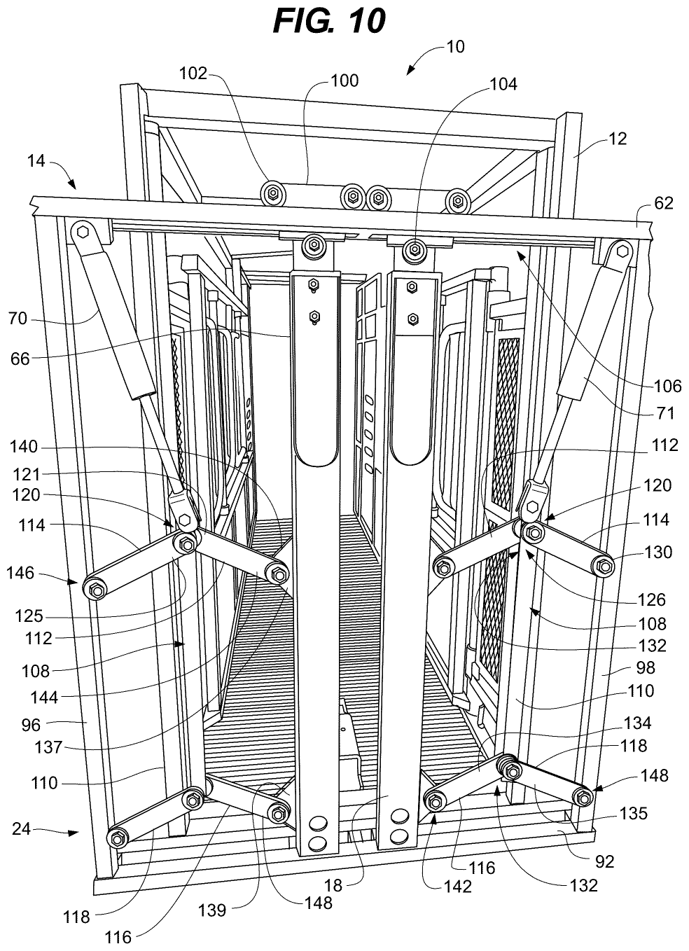

While FIGS. 7 and 8, shows the manner in which a top chain 72 and related components are positioned and substantially contained within the horizontal exit support bar 62 in the manner described above, in at least one embodiment there is a similarly arranged and supported bottom chain 90 positioned substantially within a hollow portion of a bottom horizontal exit support bar 92 along the base 16 of the frame 12, such as may be seen in FIGS. 5 and 6. This bottom chain 90 is arranged and supported in the same manner as the top chain 72 and is secured to the first and second exit gate members 66 and 68 with brackets 74 and 80 as illustrated in the manner shown in FIG. 9

To communicate the mechanical force needed to advance the bottom chain 90 along with the top chain 72, a connector drive shaft 94 extends directly or indirectly from one or both of the rotatable gear and spindle assemblies 88 within the top horizontal exit support bar 62 to one or both corresponding rotatable gear and spindle assemblies 88 within the bottom horizontal exit support bar 92 in the manner shown in FIG. 9. Where the connection between top chain 72 and bottom chain 90 is indirect, the chain drive system may utilize any number of secondary rotatable gear and spindle assemblies 88 and secondary drive chains 95 to establish the desired mechanical communication. In at least one embodiment the connector drive shaft 94 is contained within a vertical support member 96 of the frame 12 adjacent to the exit gate 64, such as is shown in FIG. 5.

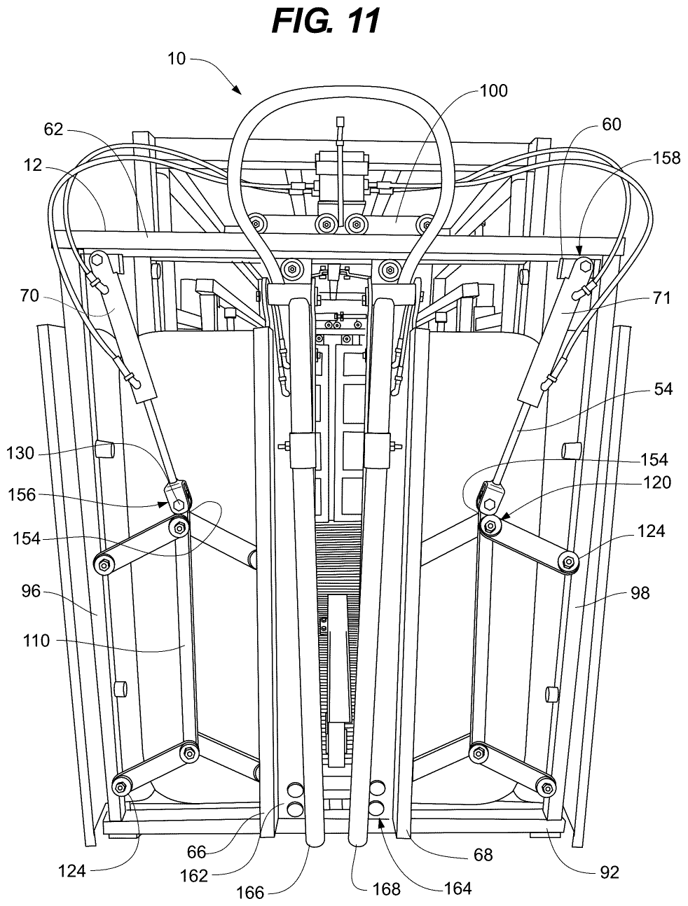

In the embodiment of the exit gate 64 described above, the nature of the chain drive system necessitates that the exit gate members 66 and 68 open and close together. i.e., movement of one gate member will always accompany the movement of the other as long as both exit gate members are connected to the drive chain 72. An alternative embodiment of the exit gate 64 is shown in FIGS. 10-12, which has been developed to allow for individual movement of each exit gate member 66 and 68.

In the embodiment shown in FIGS. 10-12, the exit end 24 of the frame 12 includes top horizontal exit support bar 62, a bottom horizontal exit support bar 92, a first vertical support member 96, and a second vertical support member 98. The first vertical support member 96 and the second vertical support member 98 are parallel to one another and extend vertically between the top horizontal exit support bar 62 and the bottom horizontal exit support bar 92.

The top horizontal exit support bar supports a first moveable exit gate member 66 and a second movable exit gate member 68, each of which are movably connected to and supported by the horizontal exit support bar 62.

In the view shown in FIG. 10, the underlying structure of the exit gate members 66 and 68 and the manner of their engagement to the top horizontal exit support bar 62 is more clearly shown. In the embodiment shown, each of the exit gate members 66 and 68 are moveably engaged to the top horizontal exit support bar 62 by a roller bracket arm 100. The roller bracket arms 100 may be similar (or the same) as the type of roller bracket arms 54 that are used to support entrance gate members 50 and 52 shown in FIGS. 3 and 4. The roller bracket arms 100 include 2-4 top wheels or rollers 102 that rest on the top side 14 of the top horizontal exit support bar 62 and 1-2 bottom wheels or rollers 104 that engage the opposing side 106 of the horizontal exit support bar 62. By essentially sandwiching the horizontal exit support bar 62 between the top wheels 102 and bottom wheels 104, the roller bracket arms 100 provide for a secure grip on the horizontal exit support bar 62 and ensure smooth and stable movement of the exit gate members 66 and 68 along the length of the top horizontal exit support bar 62.

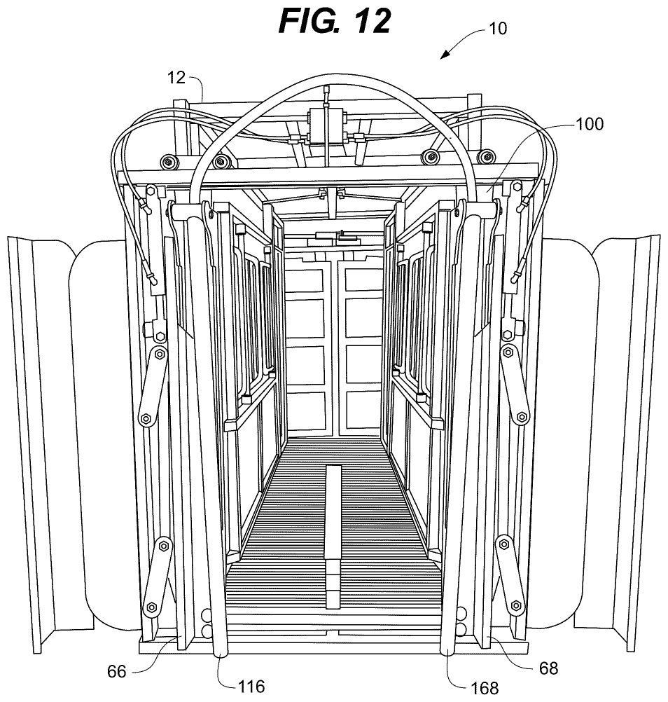

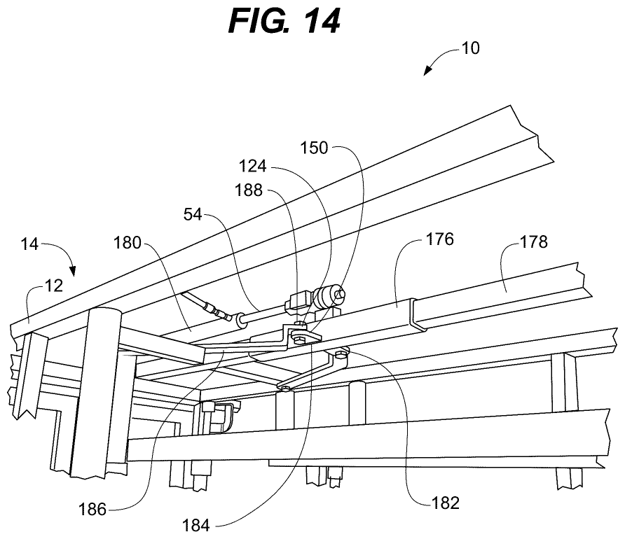

Each of the exit gate members 66 and 68 are independently moveable between the closed position shown in FIG. 11 and the open position shown in FIG. 13. Actuation of the first exit gate member 66 is provided via a first hydraulic exit cylinder 70. Actuation of the second gate member is provided via a second hydraulic exit cylinder 71. Each of the exit gate members 66 and 68 are connected to their respective hydraulic exit cylinder 70 and 71 via a six-point linkage assembly 108. Each linkage assembly includes a central link bar 110, first upper linkage arm 112, second upper linkage arm 114, first lower linkage arm 116, and second lower linkage arm 118.

The first upper linkage arm 112 and the second upper linkage arm 114 are connected to the link bar 110 at a common upper junction 120, where a first end 121 of the first upper linkage arm 112 is coupled to a first side 122 of the link bar 110, and a first end 125 of the second upper linkage arm 114 is coupled to a second side 126 of the link bar 110. A securement fastener 130 (such as a threaded bolt with a nut), passes through and secures each of the first upper linkage arm 112, link bar 110, and second upper linkage arm 114 to one another at the common upper junction 120.

The first lower linkage arm 116 and the second lower linkage arm 118 are connected to the link bar 110 at a common lower junction 132, where a first end 134 of the first lower linkage arm 116 is coupled to the first side 122 of the link bar 110 and a first end 135 of the second lower linkage arm 118 is coupled to the second side 126 of the link bar 110. A securement fastener 130, passes through and secures each of the first lower linkage arm 116, link bar 110, and the second lower linkage arm 118 to one another at the common lower junction 132.

Each of the first and second exit gate members 66 and 68 comprise a first flange 137 and a second flange 139. First flange 137 defines an upper assembly junction 140 and second flange 139 defines a lower assembly junction 142. One of the six-point linkage assemblies 108 are connected to each of the exit gate members 66 and 68 at each of the junctions 140 and 142.

In regard to the upper assembly junction 140, a second end 144 of the first upper linkage arm 112 is coupled to the first flange 137. A securement fastener 130 passes through and secures the first flange 137 and the first upper linkage arm 112 to one another at the upper assembly junction 140. In regard to the lower assembly junction 142, a second end 148 of the first lower linkage arm 116 is engaged to the second flange 139. A securement fastener 130 hat passes through and secures the second flange 139 to the first lower linkage arm 116 to one another at the lower assembly junction 142.

On the opposite side of the assemblies 108, each of the first vertical support member 96 and the second vertical support member 98 define an upper support member assembly junction 146 and a lower support member assembly junction 148.

In regard to the upper support member assembly junction 146, a second end 150 of the second upper linkage arm 114 is coupled to the upper support member assembly junction 146. A securement fastener 130 passes through and secures the second upper linkage arm 114 to one of the vertical support members 96 or 98 at the upper support member assembly junction 146. In regard to the lower support member assembly junction 148, a second end 152 of the second lower linkage arm 118 is engaged to the lower support member assembly junction 148. A securement fastener 130 passes through and secures the second lower linkage arm 118 to the one of the vertical support members 96 or 98 at the lower support member assembly junction 148.

As best shown in FIG. 11, each link bar 110 includes top extension region 154 that extends vertically beyond the upper junction 120. The top extension region 154 defines a hydraulic arm engagement junction 156 where a hydraulic arm 54 of one of the first hydraulic exit cylinder 70 or the second hydraulic exit cylinder 71 is coupled to the link bar 110, via a fastener 130, which extends through arm 54 and the top extension region 154 of the link bar 110.

Each of the first hydraulic exit cylinder 70 and the second hydraulic exit cylinder 71 include a base region 158, which is pivotally engaged to the frame 12 at a corner bracket 160, via fastener 130. Each corner bracket 160 is positioned immediately adjacent to a junction of the top horizontal exit support bar 62, and one of the vertical support member 96 and the second vertical support member 98, respectively.

In some embodiments, at each of the various junctions between the components (link bar 110, first upper linkage arm 112, second upper linkage arm 114, first lower linkage arm 116, and second lower linkage arm 118) of the six-point linkage assemblies 108, one or more roller bearings 124 are positioned between intersecting components, and which are held in place by fasteners 130. The presence of roller bearings 124 between the various components ensures smooth and quiet movement when the linkage assemblies are actuated.

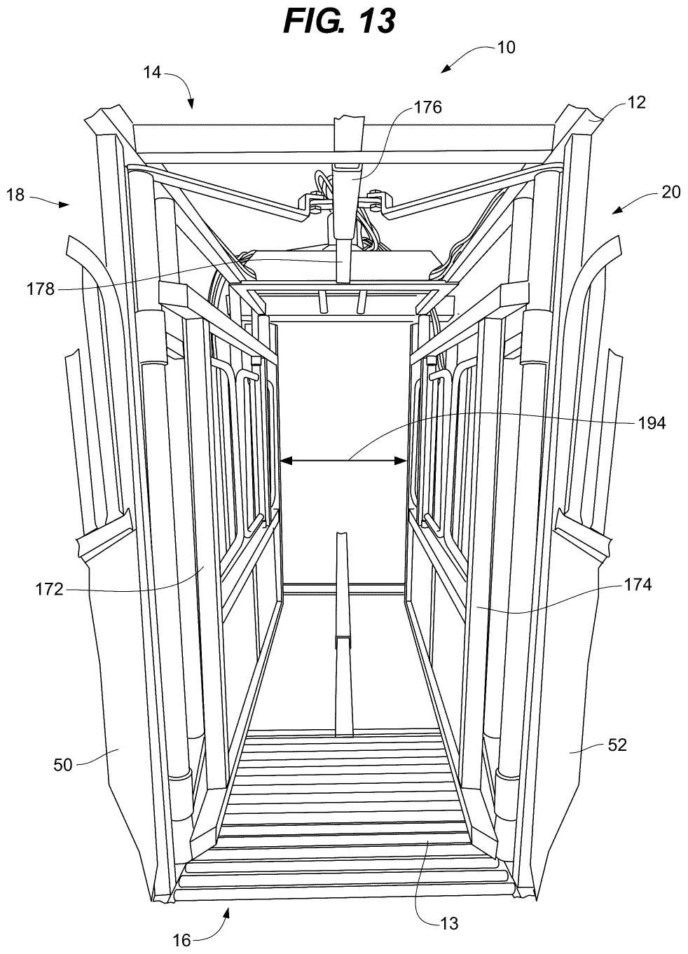

As mentioned above, moving the gate members 66 and 68 between the closed position shown in FIG. 11 and the open position in FIG. 12 is accomplished by activation of the respective first hydraulic exit cylinder 70 and second hydraulic exit cylinder 71, such that when the hydraulic arm 54 is extended, link bar 110 is pushed away from the respective hydraulic cylinder 70 or 71, which forces the corresponding gate member 66 or 68 into the closed position shown in FIG. 11, or pulls the link bar 110 toward the respective hydraulic cylinder 70 or 71, thus drawing the corresponding exit gate member 66 or 68 into the open position shown in FIG. 12.

A key benefit provided by the linkage assembly shown in FIGS. 10-12 is not only does it allow for individualized positioning of each exit gate member 66 and 68, but it ensures that the exit gate 64 is solidly braced within the frame 12 regardless of what position the gate members 66 or 68 are in.

In some embodiments, each of the exit gate members 66 and 68 define a base or foot 162 which rests upon and is slidable relative to the bottom horizontal exit support bar 92. To ensure that there is minimal, and preferably no metal on metal contact between the foot 162 and the surface of the bottom horizontal exit support bar 92, each foot 162 is provided with a resilient plastic block 164 positioned between the foot 162 and the bottom horizontal exit support bar 92. Plastic blocks 164 also act to protect the intersecting surfaces of the gate members 66 and 68 and the bottom horizontal exit support bar 92, and minimize noise that would otherwise be amplified by the sliding of the exit gate members 66 and 68 against the bottom horizontal exit support bar 92.

Common to all embodiments of the exit gate 64, such as in those depicted in FIGS. 5-6 and FIGS. 11-12, is the presence of a neck stretcher assembly which comprises a first head immobilizer shaft 166 pivotally mounted to the first exit gate member 66 and a second head immobilizer shaft 168 pivotally mounted to the second exit gate member 68. In at least one embodiment, where the squeeze chute 10 employs a chain drive assembly in the manner of the embodiments described in FIGS. 5-9, the first head immobilizer shaft 166 is mounted to bracket 74 and the second head immobilizer shaft 168 is mounted to bracket 80 in close proximity to the top horizontal exit support bar 62. In at least one embodiment, such as in the embodiment shown in FIGS. 11-12, each head immobilizer shaft 166 and 168 is mounted to a roller bracket 100.

Each of the first head immobilizer shaft 166 and second head immobilizer shaft 168 are independently actuatable via hydraulic cylinders 170 such as in the manner shown in FIG. 5. The use of a single hydraulic cylinder 170 for each immobilizer shaft 166 and 168 allows for independent movement of each immobilizer shaft 166 and 168.

Extending between the entrance gate and the exit gate, the first side 18 of the frame 12 includes a first squeeze wall 172 and a second side 20 of the frame 12 includes a second squeeze wall 174 such as may be seen in FIG. 13.

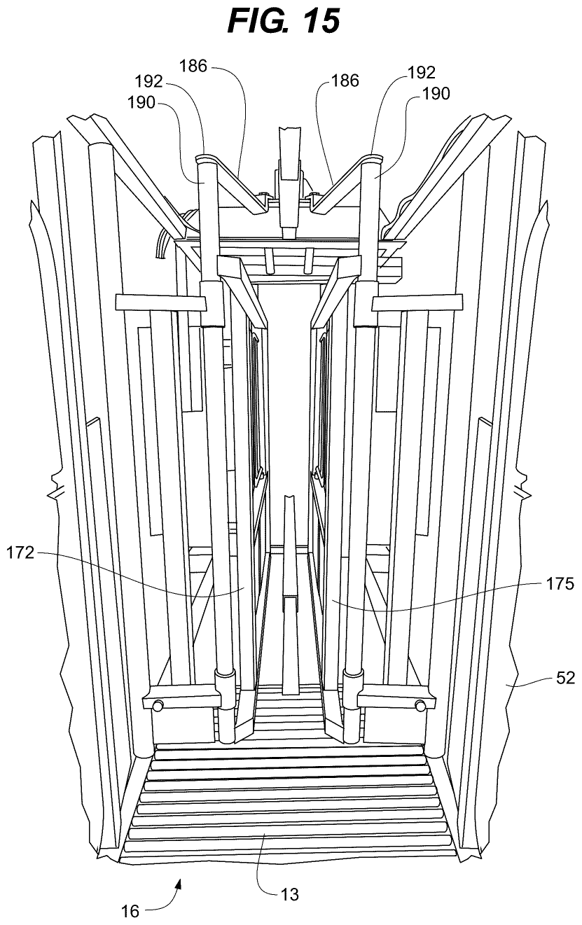

In at least one embodiment, the first and second squeeze walls 172 and 174 are pivotally engaged to a single actuation slide 176 which is disposed about an actuation rail 178 positioned along the top 14 of the frame 12. As is shown in FIG. 14, a squeeze hydraulic cylinder 180 is secured to the frame 12. The extension arm 54 of the hydraulic cylinder 180 is engaged to the actuation slide 176.

The actuation slide 176 defines a first side engagement flange 182 and a second side engagement flange 184. A linkage arm 186 has a first end 188 that is pivotally connected to each flange 182 and 184, via fastener 130. In at least one embodiment, at least one roller bearing 124 is interposed between the linkage arm 186 and the flange 182/184.

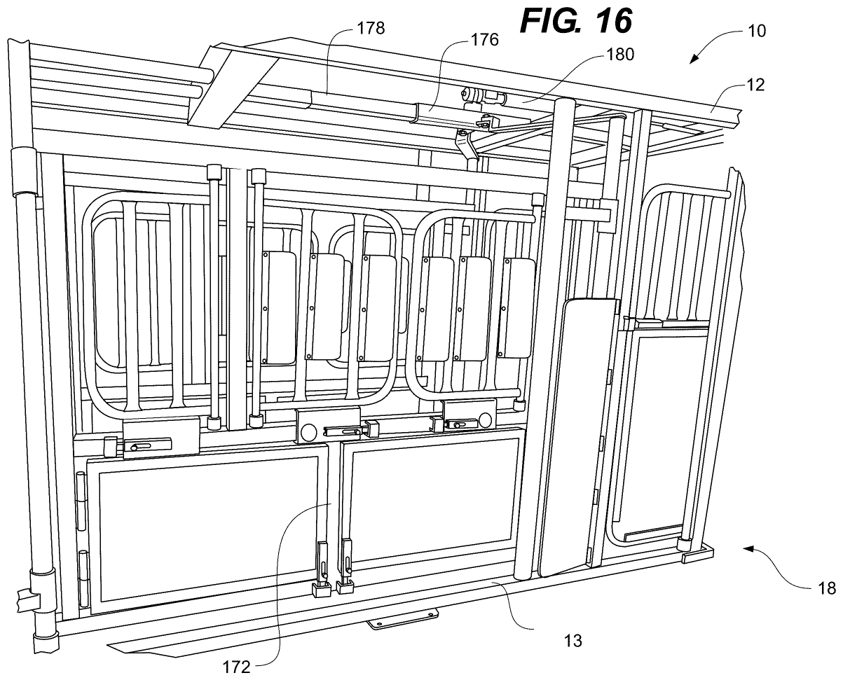

As shown in FIGS. 13 and 15, each of the first and second squeeze walls 172 and 174 include a pivot mount 190 configured to receive a second end of 192 of the linkage arm 186 therein. When thusly secured between the actuation slide 176 and the pivot mount 190, each linkage arm 186 is rotatable at both ends relative to the pivot mount 190 and the respective first side engagement flange 182 and a second side engagement flange 184.

As a result of the linkage between each of the first and second squeeze walls 172 and 174 to the actuation slide 176, when the arm 54 of the squeeze hydraulic cylinder 180 is extended by hydraulic actuation, the walls 172 and 174 are actuated between an open position shown in FIG. 13, wherein the walls 172 and 174 are a first horizontal distance apart as indicated by arrows 194, and a closed or restricted position shown in FIG. 15, wherein the walls 172 and 174 are a second horizontal distance apart as indicated by arrows 196; the first distance being greater than the second distance.

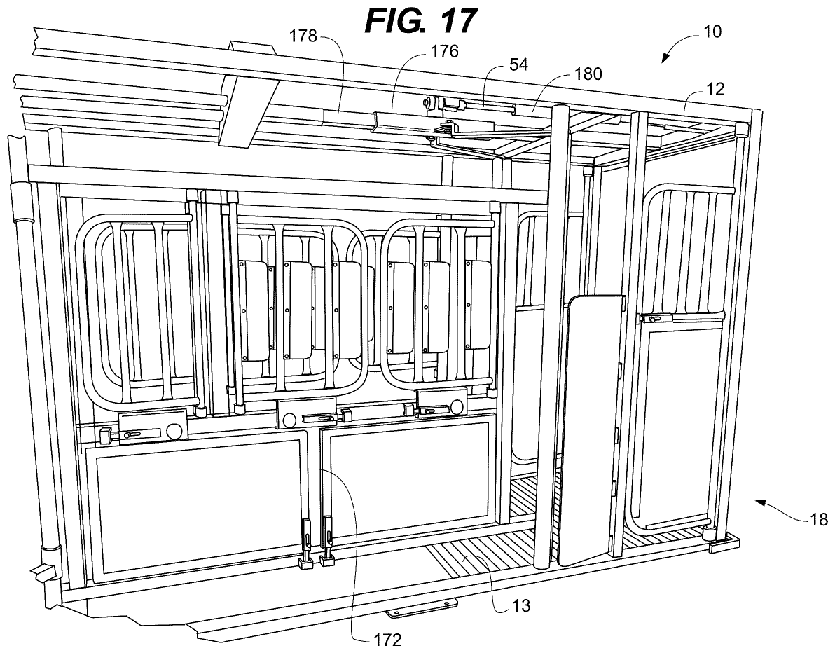

In FIG. 16, the first side 18 of the squeeze chute 10 is shown depicting the first squeeze wall 172 in the fully open position corresponding to FIG. 13.

In FIG. 17, the same first squeeze wall 172 is shown in the closed position corresponding to FIG. 15.

In this manner the squeeze chute 10 may be opened or closed as necessary in order to restrict the space available to an animal contained between the squeeze walls 172 and 174, and thereby more safely control the animal therein.

The operation of the various hydraulically actuated gates, squeeze walls, and head immobilizers is very smooth and quiet due to the resilient mounts at the base end and the arm end of all of the hydraulic cylinders. The hydraulic circuitry of the various hydraulic cylinders is such that the hydraulic cylinders are moved in a smooth and quiet fashion so that an animal is not spooked by the operation of the various components.

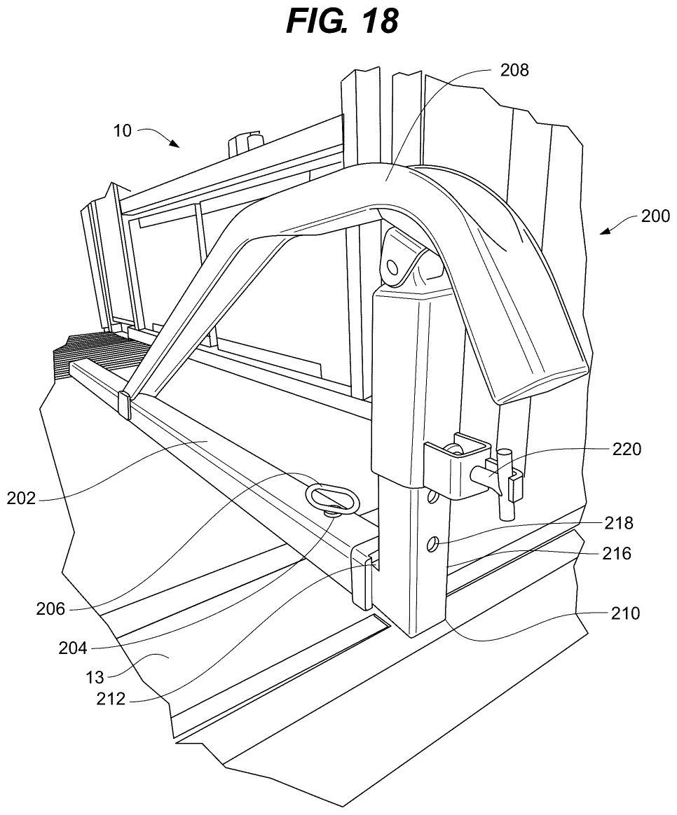

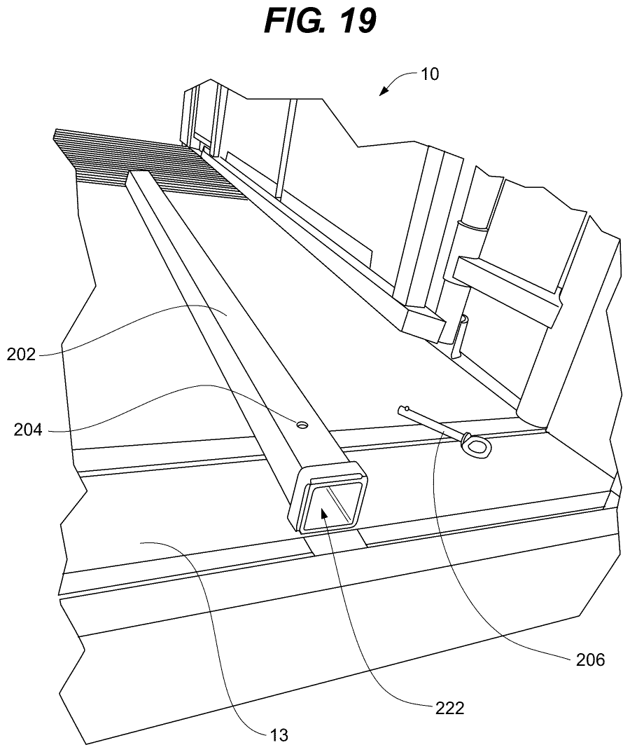

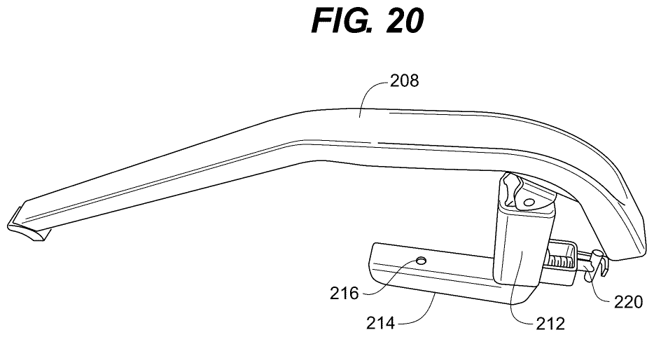

Turning to FIGS. 18-20, a sternum bar assembly 200 that is unique to the present squeeze chute 10 is shown. The sternum bar assembly 200 is positioned on the floor 13 the squeeze chute 10 in the manner show in FIG. 18. The sternum bar assembly 200 is comprised of several components, starting with a receiver shaft 202 that is bolted, welded, or otherwise securely fixed to the floor 13 such as in the manner shown in FIG. 19. The receiver shaft 202 defines a first retaining pin hole 204, which is sized to receive a retaining pin 206 therethrough. An adjustable sternum bar 208, such as is shown in FIG. 20, is engaged to an L-shaped member 210. The L-shaped member 210 includes a first segment 212 that is sized and shaped to be received into the receiver shaft 202. The first segment 212 defines a second retaining pin hole 214 that is sized and shaped to receive the retaining pin 206 therethrough when the first retaining pin hole 204 is aligned with the second retaining pin hole 214, such as in the manner shown in FIG. 18.

The L-shaped member 210, includes a second segment 216 which defines a plurality of height adjustment through holes 218 (shown in FIG. 18). Each through hole 218 is sized and shaped to receive an adjustment shaft 220. The through holes are vertically displaced on the second segment 216 to provide the user (not shown) the ability to select different through holes 218 for different heights of the sternum bar 208 relative to the floor 13. If the height of the sternum bar needs to be adjusted, the adjustment shaft 220 is removed from one of the through holes 218 and repositioned to engage another of the through holes 218.

A vertically adjustable sternum bar is removeably engaged to a sternum bar receiver which is mounted to the floor at the exit end of the squeeze chute. The receiver defines a shaft into which the adjustable sternum bar may be received and engaged to the base via a receiver pin.

As mentioned above, the present squeeze chute 10 may be provided with wheels and axles in the manner described in U.S. Pat. No. 7,677,205 to provide the squeeze chute with a ready means of portability. In at least one embodiment, the receiver shaft 202 defines a receiver opening 222 that is sized to receive a standard trailer hitch (e.g. a 2-inch “class-two” trailer hitch). Thus, when the sternum bar 208 is removed from the receiver shaft 202, it may be replaced with a standard trailer hitch to allow the squeeze chute 10 to be towed by a vehicle to a desired location.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

What is claimed is:

1. A squeeze chute apparatus comprises:
a frame, the frame a top, a base, a first side, a second side, an entrance end and an exit end, the exit end of the frame having an exit gate, the exit gate comprises:
a first horizontal exit support bar positioned at the top, the first horizontal exit support bar has a top surface and an opposing surface;
a second horizontal exit support bar positioned at the base;
a first vertical support member positioned on the first side and extending between first horizontal exit support bar and the second horizontal exit support bar, a first corner bracket positioned at a junction of the first horizontal exit support bar and the first vertical support member,
a second vertical support member positioned on the second side and extending between first horizontal exit support bar and the second horizontal exit support bar, a second corner bracket positioned at a junction of the first horizontal exit support bar and the second vertical support member;
each of the first vertical support member and the second vertical support member defining an upper support member assembly junction and a lower support member assembly junction;
a first moveable exit gate member and a second moveable gate member,
each of the first moveable exit gate member and second moveable gate member have a first flange and a second flange, the first flange defines an upper assembly junction and the second flange defines a lower assembly junction,
each of the first moveable exit gate member and the second moveable gate member have at least one roller bracket arm, each of the at least one roller bracket arms include at least two top surface rollers that are rollingly engaged to the top surface of the first horizontal exit support bar, and at least one opposing surface roller that is rollingly engaged to the opposing surface of the first horizontal exit support bar;
a first exit hydraulic cylinder and a second exit hydraulic cylinder, each of the first exit hydraulic cylinder and the second exit hydraulic cylinder defining a base and having an extension arm, the base of the first exit hydraulic cylinder being pivotally coupled to the first corner bracket, the base of the second exit hydraulic cylinder being pivotally coupled to the second corner bracket; and
a first six-point linkage assembly and a second six-point linkage assembly, each six-point linkage assembly having a link bar, a first upper linkage arm, a second upper linkage arm, a first lower linkage arm, and a second lower linkage arm,
the arm of the first exit hydraulic cylinder being pivotally connected to a top portion of the link bar of the first six-point linkage assembly, the arm of the second exit hydraulic cylinder being pivotally connected to a top portion of the link bar of the second six-point linkage assembly,
the first upper linkage arm and the second upper linkage arm being pivotally connected to the link bar at a common upper junction, the common upper junction positioned vertically below the top portion,
the first lower linkage arm and the second lower linkage arm being pivotally connected to the link bar at a common lower junction,
the first upper linkage arm of the first six-point linkage assembly being pivotally connected to the first flange of the first moveable exit gate member at the upper assembly junction,
the first lower linkage arm of the first six-point linkage assembly being pivotally connected to the second flange of the first moveable exit gate member at the lower assembly junction,
the second upper linkage arm of the first six-point linkage assembly being pivotally connected to the first vertical support member at the upper support member assembly junction,
the second lower linkage arm of the first six-point linkage assembly being pivotally connected to the first vertical support member at the lower support member assembly junction,
the first upper linkage arm of the second six-point linkage assembly being pivotally connected to the first flange of the second moveable exit gate member at the upper assembly junction,
the first lower linkage arm of the second six-point linkage assembly being pivotally connected to the second flange of the second moveable exit gate member at the lower assembly junction,
the second upper linkage arm of the second six-point linkage assembly being pivotally connected to the second vertical support member at the upper support member assembly junction,
the second lower linkage arm of the second six-point linkage assembly being pivotally connected to the second vertical support member at the lower support member assembly junction;
wherein, each of the first moveable exit gate member and the second moveable gate member being independently moveable between a closed position and an open position by independent hydraulic actuation of the first exit hydraulic cylinder and the second exit hydraulic cylinder respectively.
